(19) United States
(12) Patent Application Publication
(10) Pub. No.: US 2026/0128190 A1
(43) Pub. Date: May 7, 2026

(54) RECTANGULAR WIRE AND PRODUCTION METHOD FOR SAME

(71) Applicant: AGC Inc., Tokyo (JP)

(72) Inventors: Masatoshi ABE, Tokyo (JP); Toru SASAKI, Tokyo (JP); Tsuyoshi KAWAI, Tokyo (JP)

(73) Assignee: AGC Inc., Tokyo (JP)

(21) Appl. No.: 19/354,437

(22) Filed: Oct. 9, 2025

Related U.S. Application Data
(63) Continuation of application No. PCT/JP2024/014823, filed on Apr. 12, 2024.

(30) Foreign Application Priority Data
Apr. 12, 2023 (JP) 2023-064886

(51) Int. Cl. H01B 3/30; B29C 48/154; B29K 27/18; B29K 105/00; B29K 705/10; C08L 71/00; H01B 7/00; H01B 13/14

(52) U.S. Cl. CPC H01B 3/307; C08L 71/00; H01B 7/0009; H01B 13/14; B29C 48/154; B29K 2027/18; B29K 2105/0085; B29K 2105/0094; B29K 2705/10; C08L 2203/202

(57) ABSTRACT

The present invention pertains to a rectangular wire including:
a rectangular conductor; and
a film of an insulating coating material that directly covers the entire circumferential direction of the rectangular conductor,
wherein: a melt flow rate of the insulating coating material at a temperature of 372° C. and a load of 49 N is from 20.0 to 300.0 g/10 min;
the insulating coating material contains polyaryletherketone (A) and a fluorine-containing copolymer (B) having a unit based on tetrafluoroethylene;
an amount of the fluorine-containing copolymer (B) with respect to a total mass of the polyaryletherketone (A) and the fluorine-containing copolymer (B) in the insulating coating material is 5% by mass or more; and
the rectangular wire is such that the film of the insulating coating material does not peel off from the rectangular conductor in a winding test conforming to “JIS3216-3:2011 5.1.2 Rectangular Wire”.

This application is a continuation application of International Application No. PCT/JP2024/014823, filed on Apr. 12, 2024, which claims the benefit of priority of the prior Japanese Patent Application No. 2023-064886, filed Apr. 12, 2023 in Japan, the contents of which are incorporated herein by reference.

### BACKGROUND OF THE INVENTION

### Field of the Invention

The present invention relates to a rectangular wire and a production method of the same.

### Description of the Related Art

Vehicle equipment or the like used in automobiles, railroads, aircraft, and the like is desired to be smaller and lighter. Therefore, a film of an insulating coating material of an insulated electric wire of an electrical equipment used in the vehicle equipment is required to be thinner. Furthermore, with the increase in the output and voltage of electrical equipment, the above insulating coating material is required to have excellent insulation properties as well as strong adhesion to a conductor.

By employing a rectangular conductor as a conductor of an electric wire, the space factor is higher when it is coiled, as compared to a round wire. As a result, it is possible to save space in the entire coil, which contributes to the miniaturization of electrical equipment. However, in the case of rectangular conductors, it is more difficult to form a uniform film of an insulating coating material compared to round wires, and there is a problem in that the insulation properties cannot be sufficiently maintained.

Patent Document 1 discloses a method for producing a rectangular wire in which a powder having an average particle size of 0.02 μm or more and 150 μm or less and containing a melt-moldable fluororesin with a melting point of 100° C. or higher and 325° C. or lower and at least one functional group selected from the group consisting of a carbonyl group-containing group, a hydroxy group, an epoxy group, and an isocyanate group is coated onto a rectangular conductor, thereby forming a film of an insulating coating layer with a thickness of 10 to 150 μm on the outer periphery of the rectangular conductor.

### PRIOR ART DOCUMENTS

### Patent Document

[Patent Document 1] Japanese Unexamined Patent Application, First Publication No. 2017-204410

### SUMMARY OF THE INVENTION

### Problems to be Solved by the Invention

However, the production method described in Patent Document 1 requires a powder preparation step and a firing step after the powder coating, which results in a problem of low productivity. In addition, since the powder is coated, there is a problem of low surface smoothness of the film of the insulating coating material. Furthermore, the film of the insulating coating material exhibits low conformability with respect to the rectangular conductor, and during bending deformation of the rectangular wire, there are also problems of wrinkles forming in the film of the insulating coating material or the film of the insulating coating material peeling off from the rectangular conductor.

The present invention has an object of providing: a rectangular wire that is highly productive and exhibits excellent surface smoothness of the film of the insulating coating material and conformability of the film of the insulating coating material with respect to the rectangular conductor during bending deformation; as well as a production method thereof.

### Means for Solving the Problem

The present invention includes the following aspects.
[1] A rectangular wire including: a rectangular conductor having a rectangular cross section in a direction perpendicular to the axial direction; and a film of an insulating coating material formed by extrusion molding that directly covers the entire circumferential direction of the aforementioned rectangular conductor, wherein a melt flow rate of the aforementioned insulating coating material at a temperature of 372° C. and a load of 49 N is from 20.0 to 300.0 g/10 min, an average thickness of the film of the aforementioned insulating coating material is from 10 to 1,000 μm, an unbiased standard deviation of a thickness of the film of the aforementioned insulating coating material in the axial direction of the aforementioned rectangular wire is less than 0.06 mm, the aforementioned insulating coating material contains polyaryletherketone (A) and a fluorine-containing copolymer (B) having a unit based on tetrafluoroethylene, the aforementioned fluorine-containing copolymer (B) contains one or more selected from the group consisting of a fluorine-containing resin (B1) having a melting point of 260° C. or higher and a fluorine-containing elastomer (B2), an amount of the aforementioned fluorine-containing copolymer (B) with respect to a total mass of the aforementioned polyaryletherketone (A) and the aforementioned fluorine-containing copolymer (B) in the aforementioned insulating coating material is 5% by mass or more, and the aforementioned rectangular wire is such that the film of the aforementioned insulating coating material does not peel off from the aforementioned rectangular conductor in a winding test conforming to “JIS3216-3:2011 5.1.2 Rectangular Wire”.
[2] The rectangular wire according to [1], wherein a cross sectional area of the aforementioned rectangular conductor is 2.6 mm² or more.
[3] The rectangular wire according to [1] or [2], wherein the aforementioned fluorine-containing resin (B1) has a —CH₂OH group, and an amount of the aforementioned —CH₂OH group is more than 30 with respect to 1×10⁶ main chain carbon atoms of the aforementioned fluorine-containing resin (B1).
[4] The rectangular wire according to any one of [1] to [3], wherein the aforementioned fluorine-containing elastomer (B2) has an iodine atom, and an amount of the aforementioned iodine atom is 0.05% by mass or more with respect to a total mass of the aforementioned fluorine-containing elastomer (B2).
[5] The rectangular wire according to any one of [1] to [4], wherein a partial discharge inception voltage of the aforementioned insulating coating material is 600 Vrms or more.
[6] A method for producing a rectangular wire including a rectangular conductor having a rectangular cross section in a direction perpendicular to the axial direction, and a film of an insulating coating material formed by extrusion molding that directly covers the entire circumferential direction of the aforementioned rectangular conductor, the method including: melting a composition containing polyaryletherketone (A) and a fluorine-containing copolymer (B) having a unit based on tetrafluoroethylene using an extruder equipped with a die; and extruding the aforementioned composition that has been melted from the aforementioned die around the aforementioned rectangular conductor; thereby coating around the aforementioned rectangular conductor with the aforementioned melted composition and forming the aforementioned insulating coating material; wherein a melt flow rate of the aforementioned insulating coating material at a temperature of 372° C. and a load of 49 N is from 20.0 to 300.0 g/10 min, an average thickness of the film of the aforementioned insulating coating material is from 10 to 1,000 μm, an unbiased standard deviation of a thickness of the film of the aforementioned insulating coating material in the axial direction of the aforementioned rectangular wire is less than 0.06 mm, the aforementioned fluorine-containing copolymer (B) contains one or more selected from the group consisting of a fluorine-containing resin (B1) having a melting point of 260° C. or higher and a fluorine-containing elastomer (B2), an amount of the aforementioned fluorine-containing copolymer (B) with respect to a total mass of the aforementioned polyaryletherketone (A) and the aforementioned fluorine-containing copolymer (B) in the aforementioned composition is 5% by mass or more, and the aforementioned rectangular wire is such that the film of the aforementioned insulating coating material does not peel off from the aforementioned rectangular conductor in a winding test conforming to “JIS3216-3:2011 5.1.2 Rectangular Wire”.
[7] The method for producing a rectangular wire according to [6], wherein a drawdown ratio DDR calculated by the following Formula 1 is 0.5 or more and less than 10.0,

$$DDR = ( {D}_{A} - {C}_{A} ) / ( {F}_{A} - {C}_{A} ) \qquad Formula 1$$

In the aforementioned Formula 1, D_{A} is an opening area (mm²) of the aforementioned die, C_{A} is a cross sectional area (mm²) of the aforementioned rectangular conductor in a direction perpendicular to the axial direction, and F_{A} is a cross sectional area (mm²) of the aforementioned rectangular wire in a direction perpendicular to the axial direction.
[8] The method for producing a rectangular wire according to [6] or [7], wherein a cross sectional area of the aforementioned rectangular conductor is 2.6 mm² or more.
[9] The method for producing a rectangular wire according to any one of [6] to [8], wherein the aforementioned fluorine-containing resin (B1) has a —CH₂OH group, and an amount of the aforementioned CH₂OH group is more than 30 with respect to 1×10⁶ main chain carbon atoms of the aforementioned fluorine-containing resin (B1).
[10] The method for producing a rectangular wire according to any one of [6] to [9], wherein the aforementioned fluorine-containing elastomer (B2) has an iodine atom, and an amount of the aforementioned iodine atom is 0.05% by mass or more with respect to a total mass of the aforementioned fluorine-containing elastomer (B2).
[11] The method for producing a rectangular wire according to any one of [6] to [10], wherein a partial discharge inception voltage of the aforementioned insulating coating material is 600 Vrms or more.
[1A] A rectangular wire including: a rectangular conductor having a rectangular cross section in a direction perpendicular to the axial direction; and a film of an insulating coating material formed by extrusion molding that directly covers the entire circumferential direction of the aforementioned rectangular conductor, wherein a melt flow rate of the aforementioned insulating coating material at a temperature of 372° C. and a load of 49 N is from 20.0 to 300.0 g/10 min, from 30.0 to 250.0 g/10 min, from 40.0 to 200.0 g/10 min, or from 50.0 to 230.0 g/10 min, an average thickness of the film of the aforementioned insulating coating material is from 10 to 1,000 μm, from 20 to 500 μm, or from 50 to 200 μm, an unbiased standard deviation of a thickness of the film of the aforementioned insulating coating material in the axial direction of the aforementioned rectangular wire is less than 0.06 mm, 0.03 mm or less, 0.01 mm or less, 0.001 mm or more but less than 0.06 mm, from 0.001 to 0.03 mm, or from 0.001 to 0.01 mm, the aforementioned insulating coating material contains polyaryletherketone (A) and a fluorine-containing copolymer (B) having a unit based on tetrafluoroethylene, the aforementioned fluorine-containing copolymer (B) contains one or more selected from the group consisting of a fluorine-containing resin (B1) having a melting point of 260° C. or higher, 280° C. or higher, 290° C. or higher, from 260 to 350° C., from 280 to 340° C., or from 290 to 330° C., and a fluorine-containing elastomer (B2), an amount of the aforementioned fluorine-containing copolymer (B) with respect to a total mass of the aforementioned polyaryletherketone (A) and the aforementioned fluorine-containing copolymer (B) in the aforementioned insulating coating material is 5% by mass or more, from 5 to 45% by mass, or from 10 to 30% by mass, and the aforementioned rectangular wire is such that the film of the aforementioned insulating coating material does not peel off from the aforementioned rectangular conductor in a winding test conforming to “JIS3216-3:2011 5.1.2 Rectangular Wire”.
[2A] The rectangular wire according to [1A], wherein a cross sectional area of the aforementioned rectangular conductor is 2.6 mm² or more, 3.0 mm² or more, from 2.6 to 15 mm², or from 3.0 to 15 mm².
[3A] The rectangular wire according to [1A] or [2A], wherein the aforementioned fluorine-containing resin (B1) has a —CH₂OH group, and an amount of the aforementioned —CH₂OH group is more than 30, 60 or more, 150 or more, more than 30 and not more than 5,000, from 60 to 3,000, or from 150 to 1,000 with respect to 1×10⁶ main chain carbon atoms of the aforementioned fluorine-containing resin (B1).
[4A] A rectangular wire according to any one of [1A] to [3A], wherein the aforementioned fluorine-containing elastomer (B2) has an iodine atom, and an amount of the aforementioned iodine atom is 0.05% by mass or more, from 0.1 to 5% by mass, or from 0.2 to 1% by mass with respect to a total mass of the aforementioned fluorine-containing elastomer (B2).
[5A] A rectangular wire according to any one of [1A] to [4A], wherein a partial discharge inception voltage of the aforementioned insulating coating material is 600 Vrms or more, 700 Vrms or more, 800 Vrms or more, 900 Vrms or more, from 600 to 5,000 Vrms, from 700 to 4,000 Vrms, from 800 to 3,000 Vrms, or from 900 to 3,000 Vrms.
[6A] A method for producing a rectangular wire including a rectangular conductor having a rectangular cross section in a direction perpendicular to the axial direction, and a film of an insulating coating material formed by extrusion molding that directly covers the entire circumferential direction of the aforementioned rectangular conductor, the method including: melting a composition containing polyaryletherketone (A) and a fluorine-containing copolymer (B) having a unit based on tetrafluoroethylene using an extruder equipped with a die; and extruding the aforementioned composition that has been melted from the aforementioned die around the aforementioned rectangular conductor; thereby coating around the aforementioned rectangular conductor with the aforementioned melted composition and forming the aforementioned insulating coating material; wherein a melt flow rate of the aforementioned insulating coating material at a temperature of 372° C. and a load of 49 N is from 20.0 to 300.0 g/10 min, from 30.0 to 250.0 g/10 min, from 40.0 to 200.0 g/10 min, or from 50.0 to 230.0 g/10 min, an average thickness of the film of the aforementioned insulating coating material is from 10 to 1,000 μm, from 20 to 500 μm, or from 50 to 200 μm, an unbiased standard deviation of the thickness of the film of the aforementioned insulating coating material in the axial direction of the aforementioned rectangular wire is less than 0.06 mm, 0.03 mm or less, 0.01 mm or less, 0.001 mm or more but less than 0.06 mm, from 0.001 to 0.03 mm, or from 0.001 to 0.01 mm, the aforementioned fluorine-containing copolymer (B) contains one or more selected from the group consisting of a fluorine-containing resin (B1) having a melting point of 260° C. or higher, 280° C. or higher, 290° C. or higher, from 260 to 350° C., from 280 to 340° C., or from 290 to 330° C., and a fluorine-containing elastomer (B2), an amount of the aforementioned fluorine-containing copolymer (B) with respect to a total mass of the aforementioned polyaryletherketone (A) and the aforementioned fluorine-containing copolymer (B) in the aforementioned composition is 5% by mass or more, from 5 to 45% by mass, or from 10 to 30% by mass, and the aforementioned rectangular wire is such that the film of the aforementioned insulating coating material does not peel off from the aforementioned rectangular conductor in a winding test conforming to “JIS3216-3:2011 5.1.2 Rectangular Wire”.
[7A] The method for producing a rectangular wire according to [6A], wherein a drawdown ratio DDR calculated by the following Formula 1 is 0.1 or more and less than 10.0, 0.5 or more and less than 10.0, from 0.5 to 5, or from 0.8 to 1.5,

$$DDR = ( {D}_{A} - {C}_{A} ) / ( {F}_{A} - {C}_{A} ) \qquad Formula 1$$

In the aforementioned Formula 1, D_{A} is an opening area (mm²) of the aforementioned die, C_{A} is a cross sectional area (mm²) of the aforementioned rectangular conductor in a direction perpendicular to the axial direction, and F_{A} is a cross sectional area (mm²) of the aforementioned rectangular wire in a direction perpendicular to the axial direction.
[8A] The method for producing a rectangular wire according to [6A] or [7A], wherein a cross sectional area of the aforementioned rectangular conductor is 2.6 mm² or more, 3.0 mm² or more, from 2.6 to 15 mm², or from 3.0 to 15 mm².
[9A] The method for producing a rectangular wire according to any one of [6A] to [8A], wherein the aforementioned fluorine-containing resin (B1) has a —CH₂OH group, and an amount of the aforementioned —CH₂OH group is more than 30, 60 or more, 150 or more, more than 30 and not more than 5,000, from 60 to 3,000, or from 150 to 1,000 with respect to 1×10⁶ main chain carbon atoms of the aforementioned fluorine-containing resin (B1).
[10A] The method for producing a rectangular wire according to any one of [6A] to [9A], wherein the aforementioned fluorine-containing elastomer (B2) has an iodine atom, and an amount of the aforementioned iodine atom is 0.05% by mass or more, from 0.1 to 5% by mass, or from 0.2 to 1% by mass with respect to a total mass of the aforementioned fluorine-containing elastomer (B2).
[11A] The method for producing a rectangular wire according to any one of [6A] to [10A], wherein a partial discharge inception voltage of the aforementioned insulating coating material is 600 Vrms or more, 700 Vrms or more, 800 Vrms or more, 900 Vrms or more, from 600 to 5,000 Vrms, from 700 to 4,000 Vrms, from 800 to 3,000 Vrms, or from 900 to 3,000 Vrms.

### Effects of the Invention

According to the present invention, it is possible to provide: a rectangular wire that is highly productive and exhibits excellent surface smoothness of the film of the insulating coating material and conformability of the film of the insulating coating material with respect to the rectangular conductor during bending deformation; as well as a production method thereof.

### DETAILED DESCRIPTION OF THE INVENTION

The melt flow rate is a melt mass flow rate prescribed in JIS K 7210-1:2014 (corresponding international standard: ISO 1133-1:2011). Hereinafter, the melt flow rate will also be referred to as MFR.

The melt viscosity can be determined by a method described in Examples.

The average thickness of the film of the insulating coating material is determined by collecting 5 m of the rectangular wire, measuring the thickness of the film of the insulating coating material on the long side of the rectangular cross section in a direction perpendicular to the axial direction every 100 mm, and taking the arithmetic average.

The unbiased standard deviation of the thickness of the film of the insulating coating material in the axial direction of the rectangular wire is determined from the measured values obtained by collecting 5 m of the rectangular wire, and measuring the thickness of the film of the insulating coating material on the long side of the rectangular cross section in a direction perpendicular to the axial direction every 100 mm.

The amount of —CH₂OH group in the fluorine-containing resin (B1) can be determined by infrared spectroscopy. More specifically, it can be determined by a method described in Examples.

The amount of the iodine atom in the fluorine-containing elastomer (B2) can be determined by ion chromatography.

The melting point can be determined as a temperature corresponding to the maximum value of the melting peak measured by differential scanning calorimetry (DSC).

The partial discharge inception voltage of the insulating coating material can be determined by a method described in Examples.

The volume of the polyaryletherketone (A) or the fluorine-containing copolymer (B) is a value calculated by dividing the mass (g) of the polyaryletherketone (A) or the fluorine-containing copolymer (B) by its specific gravity (g/cm³).

The specific gravity of the polyaryletherketone (A) or the fluorine-containing copolymer (B) is a value measured at 23° C. by an underwater displacement (suspension) method.

The “number average particle size” of the fluorine-containing copolymer (B) is an average value of the maximum diameter of 100 particles each randomly selected in optical microscope observation.

The storage modulus G′ of the fluorine-containing elastomer (B2) is a value measured under conditions of 100° C. and 50 cpm in accordance with ASTM D6204.

The Mooney viscosity (ML₁₊₁₀, 121° C.) of the fluorine-containing elastomer (B2) is a value measured at 121° C. in accordance with JIS K6300-1:2000 (corresponding international standards: ISO 289-1:2005, ISO 289-2:1994).

The weld strength, thermal expansion rate, and Izod impact strength of a composition containing the polyaryletherketone (A) and the fluorine-containing copolymer (B) can be determined by methods described in Examples.

A unit of a polymer refers to a portion (polymerization unit) derived from a monomer formed by polymerization of the monomer. The unit may be a unit formed directly by a polymerization reaction, or may be a unit in which a part of the unit is converted into a different structure by processing the polymer. In the present specification, a unit based on a monomer is also referred to as a monomer unit.

### <<Rectangular Wire>>

It is provided with a rectangular conductor having a rectangular cross section in a direction perpendicular to the axial direction, and a film of an insulating coating material formed by extrusion molding that directly covers the entire circumferential direction of the aforementioned rectangular conductor. In the rectangular wire of the present embodiment, the film of the aforementioned insulating coating material does not peel off from the aforementioned rectangular conductor in a winding test conforming to “JIS3216-3:2011 5.1.2 Rectangular Wire”. In the above winding test, when the film of the aforementioned insulating coating material does not peel off from the aforementioned rectangular conductor, the surface smoothness of the film of the aforementioned insulating coating material and the conformability of the film of the insulating coating material with respect to the rectangular conductor during bending deformation are improved.

### <Rectangular Conductor>

The rectangular conductor is a core wire of the rectangular wire, and is a conductor with a rectangular cross section in a direction perpendicular to the axial direction.

The material of the rectangular conductor may be any known material for the core wire of an electric wire, and examples thereof include copper, tin, silver, gold, aluminum, and alloys thereof. Among these, copper is preferred from the viewpoint of ease of forming the rectangular conductor.

The thickness of the rectangular conductor is, for example, from 0.5 mm to 3.0 mm.

The width of the rectangular conductor is, for example, from 1.0 mm to 5.0 mm.

The thickness of the rectangular conductor is the short side of the rectangular cross section in the direction perpendicular to the axial direction. The width of the rectangular conductor is the long side of the rectangular cross section in the direction perpendicular to the axial direction.

The cross sectional area of the rectangular conductor is preferably 2.6 mm² or more, and more preferably 3.0 mm² or more. The upper limit of the cross sectional area of the rectangular conductor is not particularly limited, but it is, for example, 15 mm². The cross sectional area of the rectangular conductor is preferably from 2.6 to 15 mm², and more preferably from 3.0 to 15 mm².

The cross sectional area of the rectangular conductor is the area of the cross section in the direction perpendicular to the axial direction.

When the film of the insulating coating material exhibits low conformability with respect to the rectangular conductor during bending deformation, the larger the cross sectional area of the rectangular conductor, the more likely it is that during bending deformation of the rectangular wire, wrinkles form in the film of the insulating coating material or the film of the insulating coating material peel off from the rectangular conductor. Since the rectangular wire of the present embodiment exhibits excellent conformability of the film of the insulating coating material with respect to the rectangular conductor during bending deformation, the larger the cross sectional area of the rectangular conductor, the higher the usefulness.

### <Film of Insulating Coating Material>

The average thickness of the film of the insulating coating material is from 10 to 1,000 μm, preferably from 20 to 500 μm, and more preferably from 50 to 200 μm. When the average thickness of the film is equal to or more than the above lower limit value, the tracking resistance is excellent. When the average thickness of the film is equal to or less than the above upper limit value, the overall thickness of the rectangular wire can be made thinner, which allows the entire coil to save space when coiled, thereby contributing to the miniaturization of electrical equipment.

The unbiased standard deviation of the thickness of the film of the insulating coating material in the axial direction of the rectangular wire (hereinafter also simply referred to as “thickness variation”) is less than 0.06 mm, preferably 0.03 mm or less, and more preferably 0.01 mm or less. When the thickness variation of the film is less than (or not more than) the above upper limit value, crack resistance and tracking resistance during bending deformation are excellent.

The smaller the thickness variation of the film, the better, and it may be zero. From the viewpoints of ease of production and yield, the thickness variation of the film is preferably 0.001 mm or more.

The above lower limit values and the above upper limit values can be appropriately combined. Examples of the combination include 0.001 mm or more and less than 0.06 mm, from 0.001 to 0.03 mm, and from 0.001 to 0.01 mm, when the thickness variation of the film is not 0.

In order to make the thickness variation less than 0.06 mm, it is preferable to form the film of the insulating coating material by extrusion molding that directly covers the entire circumferential direction of the rectangular conductor. In the case of forming the film of the insulating coating material by other methods, such as powder coating, it is not preferred because the thickness variation is likely to be large. In particular, when forming the film of the insulating coating material by powder coating of a fluorine-containing resin, as compared to non-fluorine resins such as acrylic resins, epoxy resins, epoxy-acrylic resins, polyurethane resins, polyester resins, polyimide resins, polyamideimide resins, and polyesterimide resins, the variation is likely to be large due to the difficulty of adjusting the viscosity during melting.

The MFR of the insulating coating material at a temperature of 372° C. and a load of 49N is from 20.0 to 300.0 g/10 min, preferably from 30.0 to 250.0 g/10 min, more preferably from 40.0 to 200.0 g/10 min, and still more preferably from 50.0 to 230.0 g/10 min. The MFR of the insulating coating material is preferably measured after preheating at a measurement temperature (372° C.) for 5 minutes. It should be noted that when the MFR is 100.0 g/10 min or more, it is preferable to shorten the preheating time. In this case, the preheating time is preferably from 30 to 180 seconds.

When the MFR of the insulating coating material at a temperature of 372° C. and a load of 49 N is equal to or more than the above lower limit value, the surface smoothness of the film of the insulating coating material and the conformability of the film of the insulating coating material with respect to the rectangular conductor during bending deformation are improved. When the MFR of the insulating coating material at a temperature of 372° C. and a load of 49 N is equal to or less than the above upper limit value, the strength of the film of the insulating coating material is increased.

The partial discharge inception voltage of the insulating coating material is preferably 600 Vrms or more, more preferably 700 Vrms or more, still more preferably 800 Vrms or more, and particularly preferably 900 Vrms or more. The upper limit value of the partial discharge inception voltage of the insulating coating material is not particularly limited, but may be, for example, 5,000 Vrms or less, 4,000 Vrms or less, or 3,000 Vrms or less. The partial discharge inception voltage of the insulating coating material is preferably from 600 to 5,000 Vrms, more preferably from 700 to 4,000 Vrms, still more preferably from 800 to 3,000 Vrms, and particularly preferably from 900 to 3,000 Vrms.

If there are minute void-like defects and the like in the insulating coating material, the electric field concentrates at that part, and a weak discharge occurs. This discharge is a partial discharge. When the partial discharge inception voltage is equal to or higher than the above lower limit value, it means that there are few of the above defects. When the partial discharge inception voltage of the insulating coating material is equal to or higher than the above lower limit value, the adhesion of the insulating coating material with respect to the rectangular conductor is improved. As a result, the conformability of the film of the insulating coating material with respect to the rectangular conductor during bending deformation is improved.

The insulating coating material contains the polyaryletherketone (A) and the fluorine-containing copolymer (B) having a unit based on tetrafluoroethylene.

The insulating coating material may further contain other components in addition to the polyaryletherketone (A) and the fluorine-containing copolymer (B) as long as the characteristics thereof are not significantly impaired.

The total amount of the polyaryletherketone (A) and the fluorine-containing copolymer (B) with respect to the total mass of the insulating coating material is preferably 50% by mass or more, more preferably 70% by mass or more, and may be 100% by mass.

The amount of the fluorine-containing copolymer (B) with respect to the total mass of the polyaryletherketone (A) and the fluorine-containing copolymer (B) in the insulating coating material is 5% by mass or more, preferably from 5 to 45% by mass, and more preferably from 10 to 30% by mass. In other words, the amount of the polyaryletherketone (A) with respect to the total mass of the polyaryletherketone (A) and the fluorine-containing copolymer (B) in the insulating coating material is 95% by mass or less, preferably from 55 to 95% by mass or more, and more preferably from 70 to 90% by mass.

### <Polyaryletherketone (A)>

As the polyaryletherketone (A), from the viewpoints of mechanical properties and heat resistance, polyetherketone (hereinafter also referred to as “PEK”), polyetheretherketone (hereinafter also referred to as “PEEK”), or polyetherketoneketone (hereinafter also referred to as “PEKK”) is preferred, and PEEK is particularly preferred.

Although two or more types of polyaryletherketone (A) may be used in combination, it is preferred to use one type alone.

As PEEK, PEEK having a repeating unit represented by the following Formula (I) is preferred.

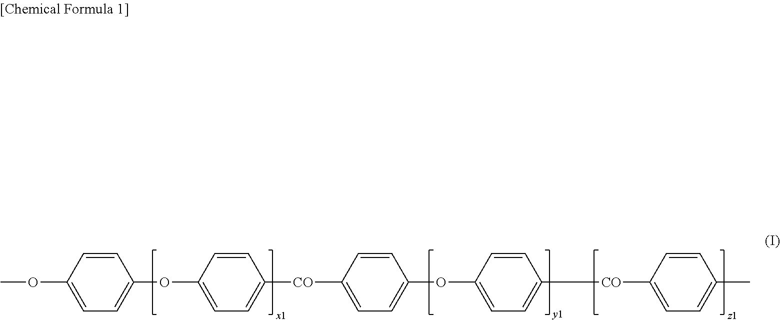

In the above Formula (I), x1 and y1 are independently 0 or 1, and z1 is 0, 1, or 2.

The melting point of the polyaryletherketone (A) is preferably from 200 to 430° C., more preferably from 250 to 400° C., and still more preferably from 280 to 380° C. When the melting point of the polyaryletherketone is equal to or higher than the lower limit value of the above range, the heat resistance of the insulating coating material is further improved. When the melting point of the polyaryletherketone is equal to or lower than the upper limit value of the above range, the deterioration of the physical properties due to the thermal decomposition of the fluorine-containing copolymer (B) during the production of the rectangular wire can be suppressed, and the characteristics (such as flexibility, impact resistance, and chemical resistance) of the fluorine-containing copolymer (B) can be maintained.

The melt viscosity of the polyaryletherketone (A) is preferably from 10 to 690 Pa·s, more preferably from 50 to 500 Pa·s, and still more preferably from 100 to 400 Pa·s, under measurement conditions of a temperature of 390° C. and a shear rate of 122 sec⁻¹.

The MFR of the polyaryletherketone (A) at a temperature of 372° C. and a load of 49 N is preferably from 20.0 to 150.0 g/10 min, and more preferably from 21.0 to 200.0 g/10 min.

When the melt viscosity and MFR of the polyaryletherketone (A) are within the above ranges, the MFR of the insulating coating material can be easily adjusted to the above range.

The polyaryletherketone (A) may be a commercially available product, or may be synthesized from various raw materials by various methods.

Examples of commercially available PEEK products include Victrex PEEK (manufactured by Victrex plc.), VESTAKEEP series (manufactured by Daicel-Evonik Ltd.), and Ketaspire (manufactured by Solvay Specialty Polymers).

Examples of commercially available PEKK products include Kepstan (manufactured by Arkema S.A.).

### <Fluorine-Containing Copolymer (B)>

The fluorine-containing copolymer (B) has a unit based on tetrafluoroethylene (hereinafter also referred to as “TFE”). The fluorine-containing copolymer (B) contains one or more selected from the group consisting of a fluorine-containing resin (B1) having a melting point of 260° C. or higher and a fluorine-containing elastomer (B2).

### (Fluorine-Containing Resin (B1))

The melting point of the fluorine-containing resin (B1) is 260° C. or higher, preferably 280° C. or higher, and more preferably 290° C. or higher. When the melting point is equal to or higher than the above lower limit value, the strength of the obtained insulating coating material is excellent.

The melting point of the fluorine-containing resin (B1) is preferably 350° C. or lower, more preferably 340° C. or lower, and still more preferably 330° C. or lower. When the melting point is equal to or lower than the above upper limit value, the elongation of the obtained insulating coating material is excellent.

The above lower limit values and the above upper limit values can be appropriately combined. Examples of the combination include from 260 to 350° C., from 280 to 340° C., and from 290 to 330° C.

The melt viscosity of the fluorine-containing resin (B1) is preferably from 100 to 1,400 Pa·s, more preferably from 300 to 1,300 Pa·s, and still more preferably from 500 to 1,200 Pa·s, under measurement conditions of a temperature of 390° C. and a shear rate of 122 sec⁻¹.

The MFR of the fluorine-containing resin (B1) at a temperature of 372° C. and a load of 49 N is preferably from 10.0 to 300.0/10 min, more preferably from 12.0 to 200.0 g/10 min, still more preferably from 15.0 to 150.0 g/10 min, and particularly preferably from 18 to 80 g/10 min.

When the melt viscosity and MFR of the fluorine-containing resin (B1) are within the above ranges, the MFR of the insulating coating material can be easily adjusted to the above range.

The fluorine-containing resin (B1) has a TFE unit and other units other than the TFE unit.

Examples of other units include a unit u1 based on a monomer having fluorine other than the TFE unit, a unit u2 based on a monomer having a functional group (excluding monomers having fluorine), and a unit u3 based on a monomer having no fluorine (excluding monomers having a functional group).

As the monomer having fluorine for the unit u1, a fluorine-containing compound having one polymerizable carbon-carbon double bond is preferred. Examples thereof include a fluoroolefin (for example, vinyl fluoride, vinylidene fluoride, trifluoroethylene, hexafluoropropylene (hereinafter also referred to as “HFP”), chlorotrifluoroethylene, hexafluoroisobutylene, or the like, excluding TFE), perfluoro (alkyl vinyl ether) (hereinafter also referred to as “PAVE”), CF₂═CFOR^{f2}SO₂X¹ (provided that R^{f2} is a perfluoroalkylene group having 1 to 10 carbon atoms which may contain an oxygen atom between the carbon atoms, and X1 is a halogen atom or a hydroxyl group), CF₂═CFOR^{f3}CO₂X² (provided that R^{f3} is a perfluoroalkylene group having 1 to 10 carbon atoms which may contain an oxygen atom between the carbon atoms, and X² is a hydrogen atom or an alkyl group having 1 to 3 carbon atoms), CF₂═CF(CF₂)ₚOCF═CF₂ (provided that p is 1 or 2), fluoroalkylethylene (hereinafter also referred to as “FAE”), and a fluorine-containing monomer having a ring structure (for example, perfluoro (2,2-dimethyl-1,3-dioxole), 2,2,4-trifluoro-5-trifluoromethoxy-1,3-dioxole, perfluoro (2-methylene-4-methyl-1,3-dioxolane), or the like). One type of the monomer having fluorine may be used alone, or two or more types thereof may be used in combination.

As the monomer having fluorine for the unit u1, at least one selected from the group consisting of HFP, PAVE and FAE is preferred from the viewpoint of excellent moldability of the composition containing the fluorine-containing resin (B1), and HFP and PAVE are more preferred and PAVE is particularly preferred from the viewpoint of excellent electrical properties (dielectric constant, dielectric loss tangent) and heat resistance.

Examples of PAVE include CF₂═CFOR^{f1} (provided that R^{f1} is a perfluoroalkyl group having 1 to 10 carbon atoms which may contain an oxygen atom between the carbon atoms).

Specific examples of PAVE include CF₂═CFOCF₂CF₃, CF₂═CFOCF₂CF₂CF₃ (hereinafter also referred to as “PPVE”), CF₂═CFOCF₂CF₂CF₂CF₃, and CF₂═CFO(CF₂)₆F.

PPVE is preferred as PAVE.

Examples of FAE include CH₂═CX³(CF₂)_{q}X⁴ (provided that X³ is a hydrogen atom or a fluorine atom, q is an integer from 2 to 10, and X⁴ is a hydrogen atom or a fluorine atom).

Specific examples of FAE include CH₂═CF(CF₂)₂F, CH₂═CF(CF₂)₃F, CH₂═CF(CF₂)₄F, CH₂═CF(CF₂)₅F, CH₂═CF(CF₂)₆F, CH₂═CF(CF₂)₂H, CH₂═CF(CF₂)₃H, CH₂═CF(CF₂)₄H, CH₂═CF(CF₂)₅H, CH₂═CF(CF₂)₆H, CH₂═CH(CF₂)₂F, CH₂═CH(CF₂)₃F, CH₂═CH(CF₂)₄F, CH₂═CH(CF₂)₅F, CH₂═CH(CF₂)₆F, CH₂═CH(CF₂)₂H, CH₂═CH(CF₂)₃H, CH₂═CH(CF₂)₄H, CH₂═CH(CF₂)₅H, and CH₂═CH(CF₂)₆H.

As FAE, CH₂═CH(CF₂)_{q1}X⁴ (provided that q1 is from 2 to 6, and preferably from 2 to 4) is preferred, CH₂═CH(CF₂)₂F, CH₂═CH(CF₂)₃F, CH₂═CH(CF₂)₄F, CH₂═CF(CF₂)₃H and CH₂—CF(CF₂)₄H are more preferred, and CH₂═CH(CF₂)₄F and CH₂═CH(CF₂)₂F are particularly preferred.

Examples of the monomer having a functional group for the unit u2 include monomers having a carboxy group (such as maleic acid, itaconic acid, citraconic acid, and undecylenic acid); monomers having an acid anhydride group (such as itaconic anhydride (hereinafter also referred to as “IAH”), citraconic anhydride (hereinafter also referred to as “CAH”), 5-norbornene-2,3-dicarboxylic anhydride (hereinafter also referred to as “NAH”), and maleic anhydride), and monomers having a hydroxyl group and an epoxy group (such as hydroxybutyl vinyl ether and glycidyl vinyl ether). One type of the monomer having a functional group may be used alone, or two or more types thereof may be used in combination. The term “acid anhydride group” means a group represented by —C(═O)—O—C(═O)—.

As the monomer having a functional group for the unit u2, a monomer having an acid anhydride group is preferred, and one or more selected from the group consisting of IAH, CAH and NAH are preferred, IAH or NAH is more preferred, and NAH is still more preferred. By using one or more selected from the group consisting of IAH, CAH and NAH, the fluorine-containing resin (B1) having an acid anhydride group can be easily produced without using a special polymerization method (see Japanese Unexamined Patent Application, First Publication No. Hei 11-193312) that is required when maleic anhydride is used.

As the monomer having no fluorine for the unit u3, a fluorine-free compound having one polymerizable carbon-carbon double bond is preferred, and examples thereof include olefins (such as ethylene, propylene, and 1-butene) and vinyl esters (such as vinyl acetate). One type of the monomer having no fluorine may be used alone, or two or more types thereof may be used in combination.

As the fluorine-containing resin (B1), for example, a fluorine-containing resin having a TFE unit and a PAVE unit (hereinafter also referred to as “PFA”), a fluorine-containing resin having a TFE unit and an HFP unit (hereinafter also referred to as “FEP”), and a fluorine-containing resin having a TFE unit and an ethylene unit are preferred, and PFA and FEP are preferred and PFA is particularly preferred from the viewpoint of electrical properties (dielectric constant, dielectric loss tangent) and heat resistance.

The fluorine-containing resin (B1) preferably has at least one functional group selected from the group consisting of a carbonyl group-containing group, a hydroxy group, an epoxy group, and an isocyanate group. The fluorine-containing resin (B1) is easily dispersed in the polyaryletherketone (A) by having a functional group. In addition, the functional group bonds with an atom on the surface of the rectangular conductor, thereby improving the adhesion of the insulating coating material with respect to the rectangular conductor. As a result, the conformability of the film of the insulating coating material with respect to the rectangular conductor during bending deformation is improved.

The functional group is preferably present in either one or both of the terminal group of the main chain of the fluorine-containing resin (B1) and the pendant group of the main chain. The term “main chain” refers to the main carbon chain of a chain compound, and means a trunk portion with the maximum number of carbon atoms.

From the viewpoint of dispersibility in the polyaryletherketone (A), the functional group is preferably a carbonyl group-containing group.

The carbonyl group-containing group is a group having a carbonyl group —C(═O)— in the structure. Examples of the carbonyl group-containing group include a group having a carbonyl group between carbon atoms of a hydrocarbon group, a carbonate group, a carboxy group, a haloformyl group, an alkoxycarbonyl group, and an acid anhydride group.

Examples of the hydrocarbon group in the group having a carbonyl group between carbon atoms of a hydrocarbon group include an alkylene group having 2 to 8 carbon atoms. It should be noted that the number of carbon atoms in the above alkylene group is a number of carbon atoms that does not include the carbon constituting the carbonyl group. The alkylene group may be linear or branched.

A haloformyl group is represented by —C(═O)—X (provided that X is a halogen atom). Examples of the halogen atom in the haloformyl group include a fluorine atom and a chlorine atom, and a fluorine atom is preferred. That is, a fluoroformyl group (also known as a carbonyl fluoride group) is preferred as the haloformyl group.

As the alkoxy group in the alkoxycarbonyl group, an alkoxy group having 1 to 8 carbon atoms is preferred, and a methoxy group or an ethoxy group is particularly preferred. The alkoxy group may be linear or branched.

Examples of the fluorine-containing resin (B1) having a functional group include the following, depending on the difference in the production method.

Fluorine-containing resin (B1-1): a fluorine-containing resin having a functional group derived from at least one selected from the group consisting of a monomer, a chain transfer agent and a polymerization initiator used in the production of the fluorine-containing resin.

Fluorine-containing resin (B1-2): a fluorine-containing resin obtained by introducing a functional group into a fluorine-containing resin having no functional group by a surface treatment such as a corona discharge treatment or a plasma treatment.

Fluorine-containing resin (B1-3): a fluorine-containing resin obtained by graft polymerization of a monomer having a functional group onto a fluorine-containing resin having no functional group.

Of these, the fluorine-containing resin (B1-1) is preferred as a functional group-containing fluorine resin.

When the functional group in the fluorine-containing resin (B1-1) is derived from a monomer used in the production of the fluorine-containing resin (B1-1), the above-mentioned monomer having a functional group for the unit u2 may be used as the monomer.

When the functional group in the fluorine-containing resin (B1-1) is derived from a chain transfer agent used in the production of the fluorine-containing resin (B1-1), a chain transfer agent having a functional group, such as acetic acid, acetic anhydride, methyl acetate, ethylene glycol, and propylene glycol may be used as the chain transfer agent. In this case, the functional group is present as a terminal group of the main chain of the fluorine-containing resin (B1-1).

When the functional group in the fluorine-containing resin (B1-1) is derived from a polymerization initiator used in the production of the fluorine-containing resin (B1-1), a polymerization initiator having a functional group, such as di-n-propyl peroxydicarbonate, diisopropyl peroxycarbonate, tert-butyl peroxyisopropyl carbonate, bis(4-tert-butylcyclohexyl) peroxydicarbonate, and di-2-ethylhexyl peroxydicarbonate may be used as the polymerization initiator. In this case, the functional group is present as a terminal group of the main chain of the fluorine-containing resin (B1-1).

The functional group in the fluorine-containing resin (B1-1) may be derived from two or more of the monomer, chain transfer agent, and polymerization initiator used in the production of the fluorine-containing resin (B1-1).

The fluorine-containing resin (B1-1) is preferably one having a functional group derived from a monomer used in the production of the fluorine-containing resin (B1-1) in view of ease of control of the amount of the functional group.

From the viewpoint of thermal stability, the fluorine-containing resin (B1-1) having a functional group derived from a monomer is preferably a fluorine-containing polymer having TFE, a unit u2 based on a cyclic hydrocarbon monomer having an acid anhydride group (hereinafter also referred to as an “acid anhydride group-containing cyclic hydrocarbon monomer”), and a unit u1 based on a monomer having fluorine other than the TFE unit. The acid anhydride group of the unit u2 corresponds to the functional group.

The amount of the functional group in the fluorine-containing resin (B1) is preferably from 10 to 60,000, more preferably from 100 to 50,000, still more preferably from 100 to 10,000, and particularly preferably from 300 to 5,000, with respect to 1×10⁶ main chain carbon atoms of the fluorine-containing resin (B1). When the amount of the functional group is equal to or more than the above lower limit value, the dispersibility is excellent, and when it is equal to or less than the above upper limit value, the thermal stability is excellent.

The amount of the functional group can be measured by a method such as nuclear magnetic resonance (NMR) analysis or infrared absorption spectrum analysis. For example, as described in Japanese Unexamined Patent Application, First Publication No. 2007-314720, a proportion (mol %) of units having a functional group in all units constituting the fluorine-containing resin (B1) can be determined using a method such as infrared absorption spectrum analysis, and the amount of the functional group can be calculated from the above proportion.

The fluorine-containing resin (B1) preferably has a —CH₂OH group as a functional group. The amount of the —CH₂OH group is preferably more than 30, more preferably 60 or more, and still more preferably 150 or more, with respect to 1×10⁶ main chain carbon atoms of the aforementioned fluorine-containing resin (B1). The upper limit value of the amount of the —CH₂OH group is not particularly limited, but may be, for example, 5,000 or less, 3,000 or less, or 1,000 or less. The amount of the —CH₂OH group is preferably more than 30 and 5,000 or less, more preferably from 60 to 3,000, and still more preferably from 150 to 1,000, with respect to 1×10⁶ main chain carbon atoms of the aforementioned fluorine-containing resin (B1).

When the amount of the —CH₂OH group in the fluorine-containing resin (B1) is equal to or more than the above lower limit value, the —CH₂OH group bonds with an atom on the surface of the rectangular conductor, thereby improving the adhesion of the insulating coating material with respect to the rectangular conductor. As a result, the conformability of the film of the insulating coating material with respect to the rectangular conductor during bending deformation is improved.

It should be noted that the amount of the —CH₂OH group can be reduced by subjecting the fluorine-containing resin (B1) having a —CH₂OH group to fluorination treatment. Further, the amount of the —CH₂OH group can also be controlled by controlling the type and amount of the chain transfer agent, polymerization initiator, and monomer, and the reaction conditions.

Preferred amounts and ratios of each unit in the fluorine-containing resin (B1) are as follows.

The amount of the TFE unit with respect to the total amount of the structural unit of the fluorine-containing resin (B1) is preferably from 90.0 to 99.9 mol %, more preferably from 95.0 to 99.5 mol %, and still more preferably from 96.0 to 99.0 mol %.

When the fluorine-containing resin (B1) contains the unit u1, the amount of the unit u1 with respect to the total amount of the structural unit of the fluorine-containing resin (B1) is preferably from 0.1 to 10.0 mol %, and more preferably from 0.5 to 5.0 mol %.

When the fluorine-containing resin (B1) contains the unit u2, the amount of the unit u2 with respect to the total amount of the structural unit of the fluorine-containing resin (B1) is preferably from 0.01 to 1.0 mol %, and more preferably from 0.05 to 0.5 mol %.

When the fluorine-containing resin (B1) contains the unit u3, the amount of the unit u3 with respect to the total amount of the structural unit of the fluorine-containing resin (B1) is preferably more than 0 mol % and not more than 1.0 mol %. In one embodiment, it is preferable that the fluorine-containing resin (B1) does not contain the unit u3.

When the fluorine-containing resin (B1) contains any one of the units u1 to u3, the total amount of the units u1 to u3 with respect to the total amount of the structural unit of the fluorine-containing resin (B1) is preferably from 0.01 to 10.0 mol %, and more preferably from 0.05 to 5.0 mol %.

When the fluorine-containing resin (B1) contains any one of the units u1 to u3, the total amount of the TFE unit and the units u1 to u3 with respect to the total amount of the structural unit of the fluorine-containing resin (B1) is preferably 90 mol % or more, more preferably 95 mol % or more, and still more preferably 100 mol %.

When the amount of each unit is within the above range, the surface smoothness of the film of the insulating coating material and the conformability of the film of the insulating coating material with respect to the rectangular conductor during bending deformation are improved in the obtained rectangular wire.

The ratio of each unit can be calculated by melt NMR analysis, fluorine amount analysis, infrared absorption spectrum analysis, or the like of the fluorine-containing resin (B1).

The fluorine-containing resin (B1) may contain a unit based on a dicarboxylic acid (itaconic acid, citraconic acid, 5-norbornene-2,3-dicarboxylic acid, maleic acid, or the like) corresponding to the acid anhydride group-containing cyclic hydrocarbon monomer as a result of hydrolysis of a portion of the acid anhydride group in the unit u2. When the above unit based on a dicarboxylic acid is contained, this unit is regarded as a unit u2.

Preferred specific examples of the fluorine-containing resin (B1) include a copolymer of TFE and PAVE, such as a TFE/PPVE copolymer and a TFE/PAVE/NAH copolymer. Examples of the copolymer of TFE and HFP include a TFE/HFP copolymer and a TFE/HFP/PAVE copolymer. Examples of the copolymer of TFE and E include a TFE/E/HFP copolymer, a TFE/E/CH₂═CH(CF₂)₂F copolymer, a TFE/E/CH₂═CH(CF₂)₄F copolymer, a TFE/E/CH₂═CH(CF₂)₂F/CH₂═CH(CF₂)₄F copolymer, a TFE/E/HFP/IAH copolymer, a TFE/E/CH₂═CH(CF₂)₂F/IAH copolymer, a TFE/E/CH₂═CH(CF₂)₄F/IAH copolymer, and a TFE/E/CH₂═CH(CF₂)₂F/CH₂═CH(CF₂)₄F/IAH copolymer.

The fluorine-containing resin (B1) may be produced by a known production method, or a commercially available product may be used. Examples of known production methods include methods described in International Patent Publication No. 2015/182702, International Patent Publication No. 2016/006644, and International Patent Publication No. 2016/017801.

### (Fluorine-Containing Elastomer (B2))

The fluorine-containing elastomer (B2) is a fluorine-containing elastic copolymer having no melting point and exhibiting a storage modulus G′ of 80 or more at 100° C. and 50 cpm, and is distinguished from the fluorine-containing resin (B1).

The melt viscosity of the fluorine-containing elastomer (B2) is preferably from 10 to 2,500 Pa·s, more preferably from 100 to 2,300 Pa·s, and still more preferably from 200 to 2,000 Pa·s, under measurement conditions of a temperature of 300° C. and a shear rate of 122 sec-1.

The MFR of the fluorine-containing elastomer (B2) at a temperature of 230° C. and a load of 21 Nis preferably from 0.1 to 300.0 g/10 min, more preferably from 1.0 to 200.0 g/10 min, and still more preferably from 40.0 to 150.0 g/10 min.

When the melt viscosity and MFR of the fluorine-containing elastomer (B2) are within the above ranges, the MFR of the insulating coating material can be easily adjusted to the above range.

The storage modulus G′ of the fluorine-containing elastomer (B2) is preferably from 80 to 800 kPa, more preferably from 100 to 800 kPa, and still more preferably from 120 to 600 kPa. A larger storage modulus G′ indicates that the fluorine-containing elastomer (B2) has a larger molecular weight and also a higher density of molecular chain entanglement. When the storage modulus G′ of the fluorine-containing elastomer (B2) is within the above range, the insulating coating material exhibits even better mechanical properties such as tensile strength.

The number average molecular weight of the fluorine-containing elastomer (B2) is preferably from 10,000 to 1,500,000, more preferably from 20,000 to 1,000,000, still more preferably from 20,000 to 800,000, and particularly preferably from 50,000 to 600,000. When the number average molecular weight of the fluorine-containing elastomer (B2) is equal to or more than the lower limit value of the above range, the insulating coating material exhibits excellent impact resistance and mechanical properties. When the number average molecular weight of the fluorine-containing elastomer (B2) is equal to or less than the upper limit value of the above range, the fluidity and the dispersibility in the polyaryletherketone (A) are excellent. As a result, flexibility is improved. The number average molecular weight is a polystyrene equivalent molecular weight measured by producing a calibration curve using a polystyrene polymer with a known molecular weight by GPC with tetrahydrofuran as an eluent.

The Mooney viscosity (ML₁₊₁₀, 121° C.) of the fluorine-containing elastomer (B2) is preferably from 10 to 300, more preferably from 20 to 280, and still more preferably from 30 to 250. The Mooney viscosity is a measure of molecular weight. The larger the Mooney viscosity value, the larger the molecular weight. Further, the smaller the Mooney viscosity value, the smaller the molecular weight.

When the Mooney viscosity (ML₁₊₁₀, 121° C.) of the fluorine-containing elastomer (B2) is equal to or more than the lower limit value of the above range, the insulating coating material exhibits excellent impact resistance and mechanical properties. When the Mooney viscosity (ML₁₊₁₀, 121° C.) of the fluorine-containing elastomer (B2) is equal to or less than the upper limit value of the above range, the fluidity and the dispersibility in the polyaryletherketone (A) are excellent. As a result, the composition containing the fluorine-containing elastomer (B2) exhibits excellent molding processability.

The fluorine-containing elastomer (B2) has a TFE unit and other units other than the TFE unit.

Examples of other units include a unit based on a monomer m1, a unit based on a monomer m2, and a unit based on a monomer m3 shown below.

The monomer m1 is at least one monomer selected from the group consisting of HFP, vinylidene fluoride (hereinafter also referred to as “VdF”), and chlorotrifluoroethylene.

One type of the monomer m1 may be used alone, or two or more types thereof may be used in combination, and it is preferred to use one type alone. Further, the monomer m1 may not be used.

The monomer m2 is at least one monomer selected from the group consisting of ethylene (hereinafter also referred to as “E”), propylene (hereinafter also referred to as “P”), PAVE, vinyl fluoride (hereinafter also referred to as “VF”), 1,2-difluoroethylene (hereinafter also referred to as “DiFE”), 1,1,2-trifluoroethylene (hereinafter also referred to as “TrFE”), 3,3,3-trifluoro-1-propylene (hereinafter also referred to as “TFP”), 1,3,3,3-tetrafluoropropylene, and 2,3,3,3-tetrafluoropropylene.

Examples of PAVE include the above-mentioned PPVE, CF₂═CFOCF₂CF₂CF₂CF₃, CF₂═CFO(CF₂)₆F, and CF₂═CFOCF₃ (hereinafter also referred to as “PMVE”). Among these, as PAVE, PMVE and PPVE are preferred, and PMVE is more preferred. One type of PAVE may be used alone, or two or more types thereof may be used in combination.

The monomer m3 has any one group of an iodine atom, an epoxy group, and an acid anhydride group at the molecular terminal, and is a monomer copolymerizable with TFE. By using the monomer m3, any one group of an iodine atom, an epoxy group and an acid anhydride group can be introduced into the fluorine-containing elastomer (B2).

The proportion of the monomer m3 unit is preferably 20 mol % or less, more preferably 5 mol % or less, and particularly preferably 0 mol %, with respect to all units constituting the fluorine-containing elastomer (B2).

Examples of the monomer m3 having an iodine atom at the molecular terminal include iodoethylene, 4-iodo-3,3,4,4-tetrafluoro-1-butene, 2-iodo-1,1,2,2-tetrafluoro-1-vinyloxyethane, 2-iodoethyl vinyl ether, allyl iodide, 1,1,2,3,3,3-hexafluoro-2-iodo-1-(perfluorovinyloxy) propane, 3,3,4,5,5,5-hexafluoro-4-iodopentene, iodotrifluoroethylene, and 2-iodoperfluoro (ethyl vinyl ether).

One type of the monomer m3 having an iodine atom at the molecular terminal may be used alone, or two or more types thereof may be used in combination.

Examples of the monomer m3 having an epoxy group at the molecular terminal include glycidyl esters of (meth)acrylic acid such as glycidyl (meth)acrylate and β-methylglycidyl (meth)acrylate; allyl glycidyl ethers such as allyl glycidyl ether and allyl methyl glycidyl ether; and alicyclic epoxy group-containing vinyl-based monomers such as 3,4-epoxycyclohexyl acrylate and 3,4-epoxycyclohexyl methacrylate.

One type of the monomer m3 having an epoxy group at the molecular terminal may be used alone, or two or more types thereof may be used in combination.

Examples of the monomer m3 having an acid anhydride group at the molecular terminal include itaconic anhydride, citraconic anhydride, 5-norbornene-2,3-dicarboxylic anhydride, and maleic anhydride.

One type of the monomer m3 having an acid anhydride group at the molecular terminal may be used alone, or two or more types thereof may be used in combination.

Examples of the fluorine-containing elastomer (B2) include the following two types of fluorine-containing copolymers.
A copolymer having a TFE unit and a P unit.
A copolymer having a TFE unit and a PAVE unit (but excluding those having a P unit or a VdF unit).

The total proportion of each unit specifically shown in these two types of fluorine-containing elastomers is preferably 50 mol % or more with respect to all units constituting the fluorine-containing elastomer.

Examples of the copolymer having a TFE unit and a P unit include the following.

A copolymer composed of a TFE unit and a P unit,
a copolymer composed of a TFE unit, a P unit and a VF unit,
a copolymer composed of a TFE unit, a P unit and a VdF unit,
a copolymer composed of a TFE unit, a P unit and an E unit,
a copolymer composed of a TFE unit, a P unit and a TFP unit,
a copolymer composed of a TFE unit, a P unit and a PAVE unit,
a copolymer composed of a TFE unit, a P unit and a 1,3,3,3-tetrafluoropropene unit,
a copolymer composed of a TFE unit, a P unit and a 2,3,3,3-tetrafluoropropene unit,
a copolymer composed of a TFE unit, a P unit and a TrFE unit,
a copolymer composed of a TFE unit, a P unit and a DiFE unit,
a copolymer composed of a TFE unit, a P unit, a VdF unit and a TFP unit, and
a copolymer composed of a TFE unit, a P unit, a VdF unit and a PAVE unit.

Among these, as the copolymer having a TFE unit and a P unit, a copolymer composed of a TFE unit and a P unit is preferred.

Examples of the copolymer having a TFE unit and a PAVE unit include copolymers composed of a TFE unit and a PAVE unit. Among these, a copolymer composed of a TFE unit and a PMVE unit and a copolymer composed of a TFE unit, a PMVE unit and a PPVE unit are preferred, and a copolymer composed of a TFE unit and a PMVE unit is more preferred.

Other examples of the fluorine-containing elastomer (B2) include, for example, a copolymer composed of a TFE unit, a VdF unit and a 2,3,3,3-tetrafluoropropylene unit.

As the fluorine-containing elastomer (B2), a copolymer having a TFE unit and a P unit, or a copolymer having a TFE unit and a PAVE unit is preferred, a copolymer having a TFE unit and a P unit is more preferred, and a copolymer composed of a TFE unit and a P unit is particularly preferred.

Since the copolymer composed of a TFE unit and a P unit exhibits favorable thermal stability during the production of the rectangular wire, the transportability during the production of the rectangular wire is stabilized. Further, coloring and foaming of the insulating coating material are reduced.

The ratio of each unit constituting the fluorine-containing elastomer (B2) is preferably within the following range from the viewpoint of easily contributing to the impact resistance of the insulating coating material.

The molar ratio of each unit in the copolymer composed of a TFE unit and a P unit (hereinafter referred to as “TFE:P”, and other molar ratios are also described in the same manner) is preferably 30 to 80:70 to 20, more preferably 40 to 70:60 to 30, and still more preferably 50 to 60:50 to 40.

In the copolymer composed of a TFE unit, a P unit and a VF unit, TFE:P:VF is preferably 30 to 60:60 to 20:0.05 to 40.

In the copolymer composed of a TFE unit, a P unit and a VdF unit, TFE:P:VdF is preferably 30 to 60:60 to 20:0.05 to 40.

In the copolymer composed of a TFE unit, a P unit and an E unit, TFE:P:E is preferably 20 to 60:70 to 30:0.05 to 40.

In the copolymer composed of a TFE unit, a P unit and a TFP unit, TFE:P:TFP is preferably 30 to 60:60 to 30:0.05 to 20.

In the copolymer composed of a TFE unit, a P unit and a PAVE unit, TFE:P:PAVE is preferably 40 to 70:60 to 29.95:0.05 to 20.

In the copolymer composed of a TFE unit, a P unit and a 1,3,3,3-tetrafluoropropene unit, TFE:P:1,3,3,3-tetrafluoropropene is preferably 30 to 60:60 to 20:0.05 to 40.

In the copolymer composed of a TFE unit, a P unit and a 2,3,3,3-tetrafluoropropene unit, TFE:P:2,3,3,3-tetrafluoropropene is preferably 30 to 60:60 to 20:0.05 to 40.

In the copolymer composed of a TFE unit, a P unit and a TrFE unit, TFE:P:TrFE is preferably 30 to 60:60 to 20:0.05 to 40.

In the copolymer composed of a TFE unit, a P unit and a DiFE unit, TFE:P:DiFE is preferably 30 to 60:60 to 20:0.05 to 40.

In the copolymer composed of a TFE unit, a P unit, a VdF unit and a TFP unit, TFE:P:VdF:TFP is preferably 30 to 60:60 to 20:0.05 to 40:0.05 to 20.

In the copolymer composed of a TFE unit, a P unit, a VdF unit and a PAVE unit, TFE:P:VdF:PAVE is preferably 30 to 70:60 to 20:0.05 to 40:0.05 to 20.

In the copolymer composed of a TFE unit, a VdF unit and an HFP unit, TFE:VdF:HFP is preferably 20 to 60:1 to 40:20 to 60.

In the copolymer composed of a TFE unit, a VdF unit, an HFP unit and a TFP unit, TFE:VdF:HFP:TFP is preferably 30 to 60:0.05 to 40:60 to 20:0.05 to 20.

In the copolymer composed of a TFE unit, a VdF unit, an HFP unit and a PAVE unit, TFE:VdF:HFP:PAVE is preferably 30 to 70:60 to 20:0.05 to 40:0.05 to 20.

In the copolymer composed of a TFE unit and a PAVE unit, TFE:PAVE is preferably 40 to 70:60 to 30. In the case of a copolymer composed of a TFE unit and a PMVE unit, TFE:PMVE is preferably 40 to 70:60 to 30.

In the copolymer composed of a TFE unit, a PMVE unit and a PPVE unit, TFE:PMVE:PPVE is preferably 40 to 70:3 to 57:3 to 57.

In the copolymer composed of a TFE unit, a VdF unit and a 2,3,3,3-tetrafluoropropylene unit, TFE:VdF: 2,3,3,3-tetrafluoropropylene is preferably 1 to 30:30 to 90:5 to 60.

One type of the fluorine-containing elastomer (B2) may be used alone or two or more types thereof may be used in combination, and it is preferred to use one type alone.

The fluorine-containing elastomer (B2) may be a commercially available product, or may be synthesized from various raw materials by various methods.

The fluorine-containing elastomer (B2) can be synthesized, for example, by polymerizing TFE and any one or more types of monomer m1, monomer m2, and monomer m3.

It is preferable to use a radical polymerization initiator during polymerization.

As the radical polymerization initiator, a compound having a half life of 10 hours at a temperature of 0 to 100° C. is preferred, and a compound having the same half life at a temperature of 20 to 90° C. is particularly preferred. Examples thereof include azo compounds (such as azobisisobutyronitrile), non-fluorine-based diacyl peroxides (such as isobutyryl peroxide, octanoyl peroxide, benzoyl peroxide, and lauroyl peroxide), peroxydicarbonates (such as diisopropyl peroxydicarbonate), peroxy esters (such as tert-butyl peroxypivalate, tert-butyl peroxyisobutyrate, and tert-butyl peroxyacetate), fluorine-containing diacyl peroxides (a compound 1 represented by the following Formula F1), and inorganic peroxides (such as potassium persulfate, sodium persulfate, and ammonium persulfate).

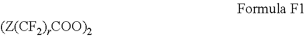

In the above Formula F1, Z is a hydrogen atom, a fluorine atom, or a chlorine atom, and r is an integer from 1 to 10.

A chain transfer agent may be used during polymerization. Examples of the chain transfer agent include a compound 2 represented by the following Formula F2, a compound 3 represented by the following Formula F3, alcohols (such as methanol and ethanol), chlorofluorohydrocarbons (such as 1,3-dichloro-1,1,2,2,3-pentafluoropropane and 1,1-dichloro-1-fluoroethane), hydrocarbons (such as pentane, hexane, and cyclohexane), and mercaptans (such as tert-dodecyl mercaptan, and n-octadecyl mercaptan).

R¹I₂ Formula F2

R²IBr Formula F3

In the above Formula F2, R¹ is an alkylene group or polyfluoroalkylene group having 2 or more carbon atoms.

In the above Formula F3, R² is an alkylene group or polyfluoroalkylene group having 1 to 16 carbon atoms.

In R¹ and R², the polyfluoroalkylene group may be linear or branched. As R¹ and R², perfluoroalkylene groups are preferred.

Examples of the compound 2 include 1,4-diiodoperfluorobutane, 1,2-diiodoperfluoroethane, 1,3-diiodoperfluoropropane, 1,5-diiodoperfluoropentane, and 1,6-diiodoperfluorohexane. Among them, 1,4-diiodoperfluorobutane is preferred. Examples of the compound 3 include 1-iodo-4-bromoperfluorobutane, 1-iodo-4-bromoperfluorobutane, 1-iodo-6-bromoperfluorohexane, and 1-iodo-8-bromoperfluoroctane.

Iodine compounds such as the compound 2 and the compound 3 can function as chain transfer agents. Therefore, when each monomer is copolymerized in the presence of an iodine compound, an iodine atom can be bonded to the main chain terminal of the fluorine-containing elastomer (B2). When obtaining a fluorine-containing elastomer (B2) having a branched chain, an iodine atom can also be bonded to the branched chain terminal in the same manner.

Examples of polymerization methods include an emulsion polymerization method, a solution polymerization method, a suspension polymerization method, and a bulk polymerization method. An emulsion polymerization method in which monomers are polymerized in the presence of an aqueous medium and an emulsifier is preferred, because the number average molecular weight and copolymer composition of the fluorine-containing elastomer (B2) can be easily adjusted, and productivity is excellent.

As the radical polymerization initiator used for emulsion polymerization, a water-soluble initiator is preferred. Examples of the water-soluble initiator include persulfuric acid, hydrogen peroxide, water-soluble organic peroxides, organic initiators, redox initiators composed of a combination of persulfuric acid or hydrogen peroxide and a reducing agent, and inorganic initiators in which a small amount of iron, ferrous salt, silver sulfate, or the like further coexists with redox initiators.

Examples of the persulfuric acid include ammonium persulfate, sodium persulfate, and potassium persulfate.

Examples of the water-soluble organic peroxide include disuccinic acid peroxide, diglutaric acid peroxide, and tert-butyl hydroxyperoxide.

Examples of the organic initiator include azobisisobutyramidine dihydrochloride. Examples of the reducing agent include sodium hydrogen sulfite and sodium thiosulfate. In the emulsion polymerization method, monomers are polymerized in the presence of an aqueous medium, an emulsifier, and a radical polymerization initiator to obtain an elastomer latex. A pH adjuster may be used during monomer polymerization.

The fluorine-containing elastomer (B2) preferably contains an iodine atom. The amount of the iodine atom is preferably 0.05% by mass or more, more preferably from 0.1 to 5% by mass, and still more preferably from 0.2 to 1% by mass with respect to the total mass of the fluorine-containing elastomer (B2).

When the iodine atom amount of the fluorine-containing elastomer (B2) is equal to or more than the above lower limit value, the iodine atom bonds with an atom on the surface of the rectangular conductor, thereby improving the adhesion of the insulating coating material with respect to the rectangular conductor. As a result, the conformability of the film of the insulating coating material with respect to the rectangular conductor during bending deformation is improved.

The amount of iodine atoms can be controlled by controlling the type and amount of the chain transfer agent containing iodine atoms and the monomer containing iodine atoms, and the reaction conditions.

### <Other Components>

Examples of other components include fluorine-containing polymers other than the fluorine-containing copolymer (B), fluorine-free polymers other than the polyaryletherketone (A), fillers, pigments, and other additives.

As specific examples of fillers, resins and inorganic fillers are preferred. Examples of the resins include fibrous resins such as aramid fibers and liquid crystal polyester fibers, and examples of powdered resins include powder resins of polytetrafluoroethylene and the like. Examples of the inorganic fillers include fibrous fillers such as glass fibers, carbon fibers, boron fibers, and stainless steel microfibers; and powdered fillers such as talc, mica, graphite, molybdenum disulfide, calcium carbonate, silica, silica alumina, alumina, and titanium dioxide.

Other examples include hydrotalcites and metal oxides, such as zinc oxide, magnesium oxide, titanium oxide, lead oxide, and copper oxide.

Further, metal powders can also be used. Examples thereof include powders of stainless steel, iron-based materials, titanium, copper, and nickel.

One type of the filler may be used alone, or two or more types thereof may be used in combination.

Examples of the pigments include color pigments such as organic pigments and inorganic pigments. Specific examples thereof include carbon black (black pigment), iron oxide (red pigment), aluminum cobalt oxide (blue pigment), copper phthalocyanine (blue pigment, green pigment), perylene (red pigment), and bismuth vanadate (yellow pigment).

One type of these other components may be used alone, or two or more types thereof may be used in combination.

### <Method for Producing Rectangular Wire>

The rectangular wire described above can be produced by a method in which a composition containing the polyaryletherketone (A) and the fluorine-containing copolymer (B) is melted using an extruder equipped with a die; and the aforementioned melted composition is extruded from the aforementioned die around a rectangular conductor; thereby coating around the aforementioned rectangular conductor with the aforementioned melted composition and forming the aforementioned insulating coating material. In addition to the fluorine-containing copolymer, the other components described above may be added to the extruder.

### (Composition)

The composition contains the polyaryletherketone (A) and the fluorine-containing copolymer (B) having a unit based on tetrafluoroethylene.

The composition may further contain other components in addition to the polyaryletherketone (A) and the fluorine-containing copolymer (B) as long as the characteristics thereof are not significantly impaired.

The total amount of the polyaryletherketone (A) and the fluorine-containing copolymer (B) with respect to the total mass of the composition is preferably 50% by mass or more, more preferably 70% by mass or more, and may be 100% by mass.

The amount of the fluorine-containing copolymer (B) with respect to the total mass of the polyaryletherketone (A) and the fluorine-containing copolymer (B) in the composition is 5% by mass or more, preferably from 5 to 45% by mass, and more preferably from 10 to 30% by mass. In other words, the amount of the polyaryletherketone (A) with respect to the total mass of the polyaryletherketone (A) and the fluorine-containing copolymer (B) in the composition is 95% by mass or less, preferably from 55 to 95% by mass, and more preferably from 70 to 90% by mass.

The MFR of the composition at a temperature of 372° C. and a load of 49 N is preferably from 19.0 to 300.0 g/10 min, more preferably from 25.0 to 250.0 g/10 min, and still more preferably from 50.0 to 200.0 g/10 min.

The weld strength of the composition is preferably 50 MPa or more, more preferably 60 MPa or more, and still more preferably 70 MPa or more. When the weld strength is equal to or more than the above lower limit value, a rectangular wire excellent in conformability of the film of the insulating coating material with respect to the rectangular conductor during bending deformation is likely to be obtained. The higher the weld strength, the better, and the upper limit value is not particularly limited. The upper limit value of the weld strength is, for example, 100 MPa. The weld strength of the composition is preferably from 50 to 100 MPa, more preferably from 60 to 100 MPa, and still more preferably from 70 to 100 MPa.

The thermal expansion rate of the composition is preferably 0.48% or less, more preferably 0.45% or less, and still more preferably 0.40% or less. When the thermal expansion rate is equal to or less than the upper limit value of the above numerical range, a rectangular wire excellent in conformability of the film of the insulating coating material with respect to the rectangular conductor during bending deformation is likely to be obtained. The lower the thermal expansion rate, the better, and the lower limit value is not particularly limited.

When the composition is formed into a test piece with a thickness of 4.0 mm, the Izod impact strength at 23° C. is preferably 80 J/m or more, more preferably 90 J/m or more, and still more preferably 100 J/m or more. When the Izod impact strength at 23° C. is equal to or more than the above lower limit value, the insulating coating material exhibits excellent impact resistance at normal temperature. The upper limit value of the Izod impact strength at 23° C. is not particularly limited, and is, for example, NB (No break).

The melting (melt kneading) is preferably carried out so that particles of the fluorine-containing copolymer (B) having a number average particle size of 0.5 to 10 μm are dispersed in the polyaryletherketone (A). By appropriately adjusting the melt-kneading temperature, the extrusion shear rate, and the residence time of the object to be melt-kneaded in the melt-kneading device, it is possible to disperse the particles of the fluorine-containing copolymer (B) having a number average particle size of 0.5 to 10 μm in the polyaryletherketone (A).

### (Production Conditions)

Examples of the extruder include a twin screw extruder and a single screw extruder, and a twin screw extruder is preferred.

The opening surface of the die has a rectangular shape.

The cylinder temperature and die temperature of the extruder are set in accordance with the types of the polyaryletherketone (A) and the fluorine-containing copolymer (B). The cylinder temperature of the extruder is preferably from 50 to 450° C., more preferably from 80 to 440° C., and still more preferably from 90 to 430° C. The die temperature is preferably from 100 to 420° C., more preferably from 120 to 400° C., and still more preferably from 150 to 380° C. When the cylinder temperature and die temperature of the extruder are equal to or higher than the above lower limit values, the compatibility of the materials by kneading is favorable. When the cylinder temperature and die temperature of the extruder are equal to or lower than the above upper limit values, deterioration of the fluorine-containing copolymer (B) due to heat is easily suppressed.

The residence time in the extruder is preferably 10 seconds or more and 30 minutes or less.

The screw rotation speed of the extruder is preferably from 0.5 to 100 rpm.

The rectangular conductor is preferably preheated. The temperature of the preheated rectangular conductor is preferably from 50 to 400° C., and more preferably from 80 to 250° C. There are no particular limitations on the preheating method, but examples thereof include optical heating, hot air heating, radiation heating, gas burner heating, and induction heating.

### (Drawdown Ratio)

In the method for producing a rectangular wire of the present embodiment, a drawdown ratio (hereinafter also referred to as “DDR”) calculated by the following Formula 1 is preferably 0.1 or more and less than 10.0, more preferably 0.5 or more and less than 10.0, still more preferably from 0.5 to 5, and particularly preferably from 0.8 to 1.5

When the DDR is equal to or more than the above lower limit value, a rectangular wire excellent in surface smoothness of the film of the insulating coating material is likely to be obtained. When the DDR is less than (or not more than) the above upper limit value, a rectangular wire excellent in surface smoothness of the film of the insulating coating material and conformability of the film of the insulating coating material with respect to the rectangular conductor during bending deformation is likely to be obtained.

$$DDR = ( {D}_{A} - {C}_{A} ) / ( {F}_{A} - {C}_{A} ) \qquad Formula 1$$

In the above Formula 1, D_{A} is an opening area (mm²) of the die, C_{A} is a cross sectional area (mm²) of the rectangular conductor in a direction perpendicular to the axial direction, and F_{A} is a cross sectional area (mm²) of the rectangular wire in a direction perpendicular to the axial direction.

D_{A} can be obtained from the following Formula 2.

$${D}_{A} = {D}_{L} \times {D}_{S} \qquad Formula 2$$

In the above Formula 2, D_{L} is an internal dimension (mm) of the long side of the rectangular opening surface of the die, and D_{S} is an internal dimension (mm) of the short side of the rectangular opening surface of the die.

C_{A} can be obtained from the following Formula 3.

$$CA = {C}_{L} \times {C}_{S} \qquad Formula 3$$

In the above Formula 3, C_{L} is a long side (mm) of the rectangular cross section of the rectangular conductor in a direction perpendicular to the axial direction, and C_{S} is a short side (mm) of the rectangular cross section of the rectangular conductor in a direction perpendicular to the axial direction.

F_{A} can be obtained from the following Formula 4.

$${F}_{A} = {F}_{L} \times {F}_{S} \qquad Formula 4$$

In the above Formula 4, F_{L} is a long side (mm) of the rectangular cross section of the rectangular wire in a direction perpendicular to the axial direction, and F_{S} is a short side (mm) of the rectangular cross section of the rectangular wire in a direction perpendicular to the axial direction.

In the present embodiment, it is preferable to adopt the so-called pressure molding method, in which the insulating coating material is formed under pressure. By adopting the pressure molding method, as compared to the conventional tube molding method, the DDR is more likely to be less than (or not more than) the above upper limit value, and as a result, a rectangular wire excellent in surface smoothness of the film of the insulating coating material and conformability of the film of the insulating coating material with respect to the rectangular conductor during bending deformation is likely to be obtained.

### (Applications)

The rectangular wire of the present invention can be suitably used in, for example, isolation amplifiers, isolation transformers, automobile alternators, hybrid vehicles, electric ships, electric aircraft, electric motors for electric vertical takeoff and landing aircraft, and the like. In addition, it can also be used as various electric wires (wrapped electric wires, electric wires for automobiles, electric wires for robots) and coil windings (magnet wires).

### EXAMPLES

The present invention will be described in more detail below with reference to Examples, but the present invention is not limited to these Examples. In the following Cases, Cases 1 to 10 are Examples of the present invention, and Cases 11 to 24 are Comparative Examples.

### <Evaluation Method>

### (MFR of Insulating Coating Material)

After preheating an insulating coating material at 372° C. for 5 minutes, the MFR at 49N was measured in accordance with JIS K 7210-1:2014. The measurement was conducted at 372° C. It should be noted that when the MFR exceeds 100 g/10 min, the preheating time may be set to 30 to 180 seconds.

### (MFR of Polyaryletherketone (A) and Fluorine-Containing Resin (B1))

The MFR at 49N was measured in accordance with JIS K 7210-1:2014. The measurement was conducted at 372° C.

### (MFR of Fluorine-Containing Elastomer (B2))

The MFR at 21 N was measured in accordance with JIS K 7210-1:2014. The measurement was conducted at 230° C.

### (Melt Viscosity of Polyaryletherketone (A) and Fluorine-Containing Copolymer (B))

The melt viscosity was measured using Capilograph (manufactured by Toyo Seiki Seisaku-sho, Ltd., capillary length L: 10 mm, capillary inner diameter r: 1.0 mm, piston diameter D: 9.55 mm). For the polyaryletherketone (A) and the fluorine-containing resin (B1), measurements were performed at a temperature of 390° C. and a shear rate of 122 sec⁻¹. For the fluorine-containing elastomer (B2), measurements were performed at a temperature of 300° C. and a shear rate of 122 sec-1.

### (Melting Points of Polyaryletherketone (A) and Fluorine-Containing Resin (B1))

Using a differential scanning calorimeter (manufactured by Seiko Instruments Inc.), the melting peak was recorded when the temperature of the polyaryletherketone (A) or the fluorine-containing resin (B1) was raised at a rate of 10° C./min, and the temperature corresponding to the local maximum value was taken as the melting point.

### (Mooney Viscosity (ML₁₊₁₀, 121° C.) of Fluorine-Containing Elastomer (B2))

It was measured at 121° C. using SMV-201 (manufactured by Shimadzu Corporation) in accordance with JIS K 6300-1:2000 (corresponding international standards: ISO 289-1:2005, ISO 289-2:1994).

### (Storage Modulus G′ of Fluorine-Containing Elastomer (B2))

It was measured using RPA 2000 (manufactured by Alpha Technologies) under conditions of 100° C. and 50 cpm in accordance with ASTM D6204.

### (Content of —CH₂OH Group in Fluorine-Containing Resin (B1))

Pellets of the fluorine-containing resin (B1) were molded by cold pressing to produce a film with a thickness of 0.25 to 0.30 mm. This film was scanned and analyzed 40 times using a Fourier transform infrared spectrophotometer (FT-IR (Spectrum One, manufactured by PerkinElmer, Inc.)) to obtain an infrared absorption spectrum 1. The same operation was also performed on pellets of a completely fluorinated fluorine-containing resin that does not have a —CH₂OH group (however, the thickness of the film was the same) to obtain an infrared absorption spectrum 2. The infrared absorption spectrum 2 was subtracted from the infrared absorption spectrum 1 to obtain a difference spectrum. The amount of the —CH₂OH group with respect to 1×10⁶ main chain carbon atoms of the fluorine-containing resin (B1) was obtained from the peak (absorbance) at 3648 cm⁻¹ in this difference spectrum using the following Formula 5. The peak at 3648 cm⁻¹ is a peak confirmed in a model compound C₇H₁₅CH₂OH having a —CH₂OH group. It should be noted that the molar absorption coefficient of the —CH₂OH group is 104 (absorbance/cm/mol).

$$N = I \times A \times t \qquad Formula 5$$

In the above Formula 5, I is absorbance, A is a correction coefficient, which is 2236 in the case of —CH₂OH group, and t is the thickness of the film (mm).

### (Iodine Amount of Fluorine-Containing Elastomer (B2))

The iodine amount of the fluorine-containing elastomer (B2) was measured using an ion chromatograph measuring device manufactured by Dia Instruments Co., Ltd. (a device obtained by combining an Automatic Quick Furnace Model AQF-100 and an ion chromatograph).

### (Weld Strength of Composition)

A pelletized composition containing polyaryletherketone (A) and fluorine-containing copolymer (B) was pre-dried for 3 hours under heating at 200° C. Subsequently, the composition was injection molded using an injection molding machine (ROBOSHOT α-50, manufactured by Fanuc Corporation) and an injection mold for weld strength measurement under the conditions of a cylinder temperature of 380° C. and a mold temperature of 170° C. to obtain a test piece in accordance with ISO 527 type 1B. With respect to this test piece, the measurement was carried out in accordance with ISO 527 by using a Tensilon universal testing machine RTF-1350 (manufactured by A & D Co., Ltd.).

### (Thermal Expansion Rate of Composition)

Pellets of the composition were molded using a heat press machine (manufactured by Tester Sangyo Co., Ltd.) under the conditions of a processing temperature of 370° C., preheating for 10 minutes, a pressure of 10 MPa, and a pressing time of 3 minutes to obtain a sheet with a thickness of 0.5 mm. A square sample of 4 mm×4 mm×0.5 mm (thickness) was cut out from the obtained sheet.

The TMA curve (horizontal axis: temperature, vertical axis: amount of deformation) of the obtained sample was measured using a TMA/SS6100, manufactured by Hitachi High-Tech Science Corporation in accordance with JIS K 7196:1991 (using penetration probe) under the conditions of a temperature setting of 30 to 390° C., a heating rate of 5° C./min, and a load of 100 mN.

The maximum dimensional change rate at which the value of the amount of deformation changed the most within a temperature range of 50 to 303° C. on the obtained TMA curve was determined and used as the thermal expansion rate.

More specifically, the dimensional change rate is calculated by the following formula.

$$Dimensional change rate ( \% ) = ( ( length in thickness direction after test ) - ( length in thickness direction before test ) ) / ( length in thickness direction before test ) \times 100$$

### (Production of Injection Molded Article for Evaluation)

A pelletized composition containing polyaryletherketone (A) and fluorine-containing copolymer (B) was pre-dried for 3 hours under heating at 200° C. Subsequently, the composition was injection molded using an injection molding machine (ROBOSHOT α-50, manufactured by Fanuc Corporation) under the conditions of a cylinder temperature of 380° C. and a die temperature of 170° C. to obtain an injection molded article for evaluation having a thickness of 4.0 mm.

### (Izod Impact Strength of Composition)

A test piece having a length of 80 mm and a width of 10 mm was cut out from the injection molded article for evaluation, and a notch was made at a height of 40 mm in the test piece.

With respect to the test piece, the Izod impact strength was measured using an Izod tester (manufactured by Toyo Seiki Seisaku-sho, Ltd.) under the conditions of a hammer capacity of 2.75 J, a hammer load of 13.97 N, a distance from the shaft center to the center of gravity of 10.54 cm, and a distance from the shaft center to the impact point of 33.5 cm. The measurements were carried out at 23° C.

### (Number Average Particle Size of Fluorine-Containing Copolymer (B) in the Composition)

The injection molded article for evaluation was observed with a scanning electron microscope (S-4800, manufactured by Hitachi, Ltd.), the maximum diameter of 100 randomly selected particles was measured, and the arithmetic average was calculated to determine the number average particle size of the fluorine-containing copolymer (B) in the composition.

### (Partial Discharge Inception Voltage of Insulating Coating Material)

The film of the insulating coating material was cut out from the rectangular wire and press molded (350° C., preheated for 5 minutes, pressurized for 2 minutes) to obtain a measurement sample of 130 mm×130 mm×0.12 mm (thickness). Using the obtained measurement sample, the partial discharge inception voltage of the insulating coating material was measured under the following measurement conditions (low frequency method). A voltage when a discharge intensity of 10 pC was detected was obtained as the partial discharge inception voltage. It should be noted that the measurement was performed on five measurement samples, and an average of these was taken as the partial discharge inception voltage. In Tables 1 to 3, the partial discharge inception voltage is indicated as PDIV.

### [Measurement Conditions]

Measuring device: Partial Discharge Detector A-006, manufactured by Fujikura Dia Cable Ltd.

Electrode: electrodes conforming to JIS C 2110-1 were used.

Test voltage: set up to a maximum of 20 kVrms (50 Hz), and reduced after detecting a discharge intensity of 100 pC.

Voltage increase/decrease rate: 100 V/sec.

Other conditions: in air, temperature: 18 degrees, relative humidity: 30%.

### (Average Thickness and Thickness Variation of Film)

5 m of rectangular wire was collected, and the thickness of the film of the insulating coating material on the long side of the rectangular cross section in a direction perpendicular to the axial direction (only the side that comes into contact with the upper inner surface of the die during molding) was measured every 100 mm.

An arithmetic mean value of the measured values (mm) was taken as the average thickness.

An unbiased standard deviation of the measured values (mm) was taken as the thickness variation.

### (Winding Test)

The rectangular wire was evaluated by a winding test in accordance with “JIS3216-3:2011 5.1.2 Rectangular Wire”. The cross section of the rectangular wire was visually confirmed and evaluated in accordance with the following criteria.
A: no peeling off of the film of the insulating coating material from the rectangular conductor.
B: peeling off of the film of the insulating coating material from the rectangular conductor.

### (Conformability)

The rectangular wire was bent and deformed in the edgewise direction and flatwise direction, respectively. The deformation angle was set to 90±10°. Thereafter, the surface of the film of the insulating coating material at the bent and deformed portion and the cross section of the rectangular wire were visually observed, and the conformability was evaluated in accordance with the following criteria.
A: no wrinkles were generated on the surface of the film of the insulating coating material during the above bending deformation, and the film of the insulating coating material did not peel off from the rectangular conductor.
B: wrinkles were generated on the surface of the film of the insulating coating material during the above bending deformation, or the film of the insulating coating material peeled off from the rectangular conductor.

### (Surface Smoothness)

The arithmetic average roughness (Ra) of the rectangular wire was measured using a digital microscope (HRX-1, manufactured by Hirox Co., Ltd.). The measurement was performed at a magnification of 80× and a length of 4 mm.
A: arithmetic average roughness of 45 μm or less
B: arithmetic average roughness of more than 45 μm

### <Materials Used>

### (Polyaryletherketone (A))

Polyaryletherketone (A1): PEEK (manufactured by Daicel-Evonik Ltd., product name “VESTAKEEP2000G”, melting point: 340° C., MFR: 64 g/10 min, melt viscosity: 290 Pa s, specific gravity: 1.32).
Polyaryletherketone (A2): PEEK (manufactured by Daicel-Evonik Ltd., product name “VESTAKEEP1000G”, melting point: 340° C., MFR: 140 g/10 min, melt viscosity: 178 Pa·s, specific gravity: 1.32).
Polyaryletherketone (A3): PEEK (manufactured by Daicel-Evonik Ltd., product name “VESTAKEEP3300G”, melting point: 340° C., MFR: 21 g/10 min, melt viscosity: 700 Pa/s, specific gravity: 1.32).

### Fluorine-Containing Copolymer (B)

Fluorine-containing resin (B1): a fluorine-containing resin with a molar ratio of TFE unit:PPVE unit:NAH unit of 97.9:2.0:0.1 (melting point: 300° C., specific gravity: 2.13, MFR: 16 g/10 min, melt viscosity: 1120 Pa·s, amount of —CH₂OH group with respect to 1×10⁶ main chain carbon atoms: 303).
Fluorine-containing elastomer (B2-1): a fluorine-containing elastomer having a molar ratio of TFE unit: P unit of 56:44 and 0.4% by mass of iodine atoms with respect to the mass of the fluorine-containing elastomer, MFR: difficult to measure (<150 g/10 min), melt viscosity: <300 Pa·s, specific gravity: 1.55, Mooney viscosity (ML₁₊₁₀, 121° C.): 50, storage modulus G′: 250 kPa).
Fluorine-containing elastomer (B2-2): a fluorine-containing elastomer having a molar ratio of TFE unit: P unit of 56:44 and no iodine atoms, MFR: 11 g/10 min, melt viscosity: 270 Pa·s, specific gravity: 1.55, Mooney viscosity (ML₁₊₁₀, 121° C.): 100, storage modulus G′: 390 kPa).

### (Case 1)

The composition with a proportion shown in Table 1 was subjected to wire extrusion molding to produce a rectangular wire under the following conditions. The DDR was set to 1. In the wire extrusion molding process, the so-called pressure molding method in which the insulating coating material was formed under pressure was employed.

Die temperature: 390° C.

Cylinder temperature: 320 to 390° C.

Rectangular conductor: a rectangular copper wire with a thickness of 1.473 mm and a width of 2.278 mm.

Preheating temperature of rectangular conductor: 180° C.

Coating thickness (set value): 0.12 mm.

### (Cases 2 to 24)

A rectangular wire was produced in the same manner as in Case 1, with the exception that the composition with a proportion shown in Tables 1 to 3 was used. However, in Cases 11 to 24, the DDR was set to 15, and the so-called tube molding method in which the insulating coating material was formed substantially under normal pressure was employed.

The insulating coating material and rectangular wire of each example were evaluated as described above. The results are shown in Tables 1 to 3.

TABLE 1

| | | | Case 1 | Case 2 | Case 3 | Case 4 | Case 5 | Case 6 | Case 7 | Case 8 | Case 9 | Case 10 |
|---|---|---|---|---|---|---|---|---|---|---|---|---|
| Proportion of | Polyarylether- | (A1) | 90 | 80 | | | | 90 | 80 | 70 | 90 | 80 |
| composition | ketone (A) | (A2) | | | 90 | 80 | 70 | | | | | |
| [% by | | (A3) | | | | | | | | | | |
| volume] | Fluorine- | (B1) | | | | | | 10 | 20 | 30 | | |
| | containing | (B2-1) | 10 | 20 | 10 | 20 | 30 | | | | | |
| | copolymer (B) | (B2-2) | | | | | | | | | 10 | 20 |

| | | | | | | | | | | | |
|---|---|---|---|---|---|---|---|---|---|---|---|
| Composition | Weld strength [MPa] | 71 | 50 | 73 | 58 | 77 | 71 | 55 | 74 | 52 | 49 |
| | Thermal expansion coefficient [%] | 0.39 | — | 0.48 | 0.40 | 0.39 | 0.41 | 0.39 | 0.39 | 0.43 | 0.40 |
| | Izod impact strength [J/m] | 122 | 135 | 102 | 110 | 115 | 91 | 121 | 118 | 105 | 113 |
| | Number average particle size of | <10 | <10 | <10 | <10 | <10 | <10 | <10 | <10 | <10 | <10 |
| | fluorine-containing copolymer (B) [μm] | | | | | | | | | | |
| Insulating | MFR [g/10 min] | 92.3 | 123.4 | 220.0 | 192.0 | 166.0 | 66.7 | 65.6 | 64.8 | 63.1 | 57.0 |
| coating | PDIV (Vrms] | 780 | 840 | 800 | 840 | 940 | 800 | 850 | 890 | 710 | 820 |
| material | | | | | | | | | | | |
| Film | Average thickness [mm] | 0.12 | 0.12 | 0.12 | 0.12 | 0.12 | 0.12 | 0.12 | 0.12 | 0.12 | 0.12 |
| | Thickness variation [mm] | <0.02 | <0.02 | <0.02 | <0.02 | <0.02 | <0.02 | <0.02 | <0.02 | <0.02 | <0.02 |
| Rectangular | Winding test | A | A | A | A | A | A | A | A | A | A |
| wire | Conformability | A | A | A | A | A | A | A | A | A | A |
| | Surface smoothness | A | A | A | A | A | A | A | A | A | A |
| | Arithmetic average roughness Ra [μm] | <15 | <15 | <15 | <15 | <15 | <15 | <15 | <15 | <15 | <15 |

TABLE 2

| | | | Case 11 | Case 12 | Case 13 | Case 14 | Case 15 | Case 16 | Case 17 |
|---|---|---|---|---|---|---|---|---|---|
| Proportion of | Polyarylether- | (A1) | | 100 | | | | | 90 |
| composition | ketone (A) | (A2) | | | | | | | |
| [% by | | (A3) | 100 | | 90 | 80 | 70 | 80 | |
| volume] | Fluorine- | (B1) | | | | | | 20 | |
| | containing | (B2-1) | | | | | | | 10 |
| | copolymer (B) | (B2-2) | | | 10 | 20 | 30 | | |

| | | | | | | | | |
|---|---|---|---|---|---|---|---|---|
| Composition | Weld strength [MPa] | 92 | 97 | 47 | 28.2 | 15.1 | 23 | 71 |
| | Thermal expansion coefficient [%] | 4.0 | 3.8 | 0.43 | 0.5 | 0.39 | 0.4 | 0.39 |
| | Izod impact strength [J/mm] | 56 | 86 | 177 | 282 | 287 | 273 | 122 |
| | Number average particle size of | — | — | <10 | <10 | <10 | <10 | <10 |
| | fluorine-containing copolymer (B) [μm] | | | | | | | |
| Insulating | MFR [g/10 min] | 18.0 | 64.0 | 18.3 | 19.3 | 19.7 | 19.5 | 92.3 |
| coating | PDIV [Vrms] | <500 | <500 | <500 | <500 | <500 | <500 | <500 |
| material | | | | | | | | |
| Film | Average thickness [mm] | 0.07 to 0.3 | 0.07 to 0.3 | 0.07 to 0.3 | 0.07 to 0.3 | 0.07 to 0.3 | 0.07 to 0.3 | 0.07 to 0.3 |
| | Thickness variation [mm] | >0.05 | >0.05 | >0.05 | >0.05 | >0.05 | >0.05 | >0.05 |
| Rectangular | Winding test | B | B | B | B | B | B | B |
| wire | Conformability | B | B | B | B | B | B | B |
| | Surface smoothness | B | B | B | B | B | B | B |
| | Arithmetic average roughness Ra [μm] | — | — | — | — | — | — | — |

TABLE 3

| | | | Case 18 | Case 19 | Case 20 | Case 21 | Case 22 | Case 23 | Case 24 |
|---|---|---|---|---|---|---|---|---|---|
| Proportion of | Polyarylether- | (A1) | 80 | | | | 90 | 80 | 70 |
| composition | ketone (A) | (A2) | | 90 | 80 | 70 | | | |
| [% by | | (A3) | | | | | | | |
| volume] | Fluorine- | (B1) | | | | | 10 | 20 | 30 |
| | containing | (B2-1) | 20 | 10 | 20 | 30 | | | |
| | copolymer (B) | (B2-2) | | | | | | | |

| | | | | | | | | |
|---|---|---|---|---|---|---|---|---|
| Composition | Weld strength [MPa] | 50 | 73 | 58 | 77 | 71 | 55 | 74 |
| | Thermal expansion coefficient [%] | — | 0.48 | 0.4 | 0.39 | 0.39 | 0.40 | 0.39 |
| | Izod impact strength [J/m] | 135 | 102 | 110 | 115 | 91 | 121 | 118 |
| | Number average particle size of | <10 | <10 | <10 | <10 | <10 | <10 | <10 |
| | fluorine-containing copolymer (B) [μm] | | | | | | | |
| Insulating | MFR [g/10 min] | 123.4 | 220.0 | 192.0 | 166.0 | 66.7 | 65.6 | 64.8 |
| coating | PDIV [Vrms] | <500 | <500 | <500 | <500 | <500 | <500 | <500 |
| material | | | | | | | | |
| Film | Average thickness [mm] | 0.07 to 0.3 | 0.07 to 0.3 | 0.07 to 0.3 | 0.07 to 0.3 | 0.07 to 0.3 | 0.07 to 0.3 | 0.07 to 0.3 |
| | Thickness variation [mm] | >0.05 | >0.05 | >0.05 | >0.05 | >0.05 | >0.05 | >0.05 |
| Rectangular | Winding test | B | B | B | B | B | B | B |
| wire | Conformability | B | B | B | B | B | B | B |
| | Surface smoothness | B | B | B | B | B | B | B |
| | Arithmetic average roughness Ra [μm] | — | — | — | — | — | — | — |

Cases 1 to 10 were excellent in surface smoothness of the film of the insulating coating material and in conformability of the film of the insulating coating material with respect to the rectangular conductor during bending deformation.

Cases 11 and 12 in which the fluorine-containing copolymer (B) was not contained were inferior in surface smoothness of the film of the insulating coating material and in conformability of the film of the insulating coating material with respect to the rectangular conductor during bending deformation.

Cases 13 to 16 in which the MFR of the insulating coating material at 372° C. and a load of 49 N was less than 20.0 g/10 min were inferior in surface smoothness of the film of the insulating coating material and in conformability of the film of the insulating coating material with respect to the rectangular conductor during bending deformation.

Cases 17 to 24 in which the fluorine-containing copolymer (B) was contained, the MFR of the insulating coating material at 372° C. and a load of 49 N was from 20.0 to 300.0 g/10 min, and the DDR was set to 15, were inferior in surface smoothness of the film of the insulating coating material and in conformability of the film of the insulating coating material with respect to the rectangular conductor during bending deformation.

What is claimed is:

1. A rectangular wire comprising:
a rectangular conductor having a rectangular cross section in a direction perpendicular to the axial direction; and
a film of an insulating coating material formed by extrusion molding that directly covers the entire circumferential direction of said rectangular conductor,
wherein: a melt flow rate of said insulating coating material at a temperature of 372° C. and a load of 49 N is from 20.0 to 300.0 g/10 min;
an average thickness of the film of said insulating coating material is from 10 to 1,000 μm;
an unbiased standard deviation of a thickness of the film of said insulating coating material in the axial direction of said rectangular wire is less than 0.06 mm;
said insulating coating material comprises polyaryletherketone (A) and a fluorine-containing copolymer (B) having a unit based on tetrafluoroethylene;
said fluorine-containing copolymer (B) comprises one or more selected from the group consisting of a fluorine-containing resin (B1) having a melting point of 260° C. or higher and a fluorine-containing elastomer (B2);
an amount of said fluorine-containing copolymer (B) with respect to a total mass of said polyaryletherketone (A) and said fluorine-containing copolymer (B) in said insulating coating material is 5% by mass or more; and
said rectangular wire is such that the film of said insulating coating material does not peel off from said rectangular conductor in a winding test conforming to “JIS3216-3:2011 5.1.2 Rectangular Wire”.

2. The rectangular wire according to claim 1, wherein a cross sectional area of said rectangular conductor is 2.6 mm² or more.

3. The rectangular wire according to claim 1,
wherein said fluorine-containing resin (B1) has a —CH₂OH group, and
an amount of said —CH₂OH group is more than 30 with respect to 1×10⁶ main chain carbon atoms of said fluorine-containing resin (B1).

4. The rectangular wire according to claim 1,
wherein said fluorine-containing elastomer (B2) has an iodine atom, and
an amount of said iodine atom is 0.05% by mass or more with respect to a total mass of said fluorine-containing elastomer (B2).

5. The rectangular wire according to claim 1, wherein a partial discharge inception voltage of said insulating coating material is 600 Vrms or more.

6. A method for producing a rectangular wire including a rectangular conductor having a rectangular cross section in a direction perpendicular to the axial direction, and a film of an insulating coating material formed by extrusion molding that directly covers the entire circumferential direction of said rectangular conductor,
the method comprising:
melting a composition containing polyaryletherketone (A) and a fluorine-containing copolymer (B) having a unit based on tetrafluoroethylene using an extruder equipped with a die; and
extruding said composition that has been melted from said die around said rectangular conductor;
thereby coating around said rectangular conductor with said melted composition and forming said insulating coating material,
wherein: a melt flow rate of said insulating coating material at a temperature of 372° C. and a load of 49 N is from 20.0 to 300.0 g/10 min;
an average thickness of the film of said insulating coating material is from 10 to 1,000 μm;
an unbiased standard deviation of a thickness of the film of said insulating coating material in the axial direction of said rectangular wire is less than 0.06 mm;
said fluorine-containing copolymer (B) comprises one or more selected from the group consisting of a fluorine-containing resin (B1) having a melting point of 260° C. or higher and a fluorine-containing elastomer (B2);
an amount of said fluorine-containing copolymer (B) with respect to a total mass of said polyaryletherketone (A) and said fluorine-containing copolymer (B) in said composition is 5% by mass or more; and
said rectangular wire is such that the film of said insulating coating material does not peel off from said rectangular conductor in a winding test conforming to “JIS3216-3:2011 5.1.2 Rectangular Wire”.

7. The method for producing a rectangular wire according to claim 6, wherein a drawdown ratio DDR calculated by the following Formula 1 is 0.5 or more and less than 10.0,
$$DDR = ( {D}_{A} - {C}_{A} ) / ( {F}_{A} - {C}_{A} ) \qquad Formula 1$$
wherein D_{A} is an opening area (mm²) of said die, C_{A} is a cross sectional area (mm²) of said rectangular conductor in a direction perpendicular to the axial direction, and F_{A} is a cross sectional area (mm²) of said rectangular wire in a direction perpendicular to the axial direction.

8. The method for producing a rectangular wire according to claim 6, wherein a cross sectional area of said rectangular conductor is 2.6 mm² or more.

9. The method for producing a rectangular wire according to claim 6,
wherein said fluorine-containing resin (B1) has a —CH₂OH group, and
an amount of said —CH₂OH group is more than 30 with respect to 1×10⁶ main chain carbon atoms of said fluorine-containing resin (B1).

10. The method for producing a rectangular wire according to claim 6,
wherein said fluorine-containing elastomer (B2) has an iodine atom, and
an amount of said iodine atom is 0.05% by mass or more with respect to a total mass of said fluorine-containing elastomer (B2).

11. The method for producing a rectangular wire according to claim 6, wherein a partial discharge inception voltage of said insulating coating material is 600 Vrms or more.
